(19) United States
(12) Patent Application Publication
(10) Pub. No.: US 2018/0147424 A1
(43) Pub. Date: May 31, 2018

(54) NASAL AIR FILTER DEVICE

(71) Applicant: KJ Biosciences LLC, College station, TX (US)

(72) Inventor: Yawei Ni, College Station, TX (US)

(73) Assignee: KJ Biosciences LLC, College Station, TX (US)

(21) Appl. No.: 15/568,700

(22) PCT Filed: Apr. 23, 2016
(86) PCT No.: PCT/US16/29074

§ 371 Date: Oct. 23, 2017

Related U.S. Application Data
(60) Provisional application No. 62/152,738, filed on Apr. 24, 2015.

(51) Int. Cl. A62B 23/06

(52) U.S. Cl. CPC A62B 23/06

(57) ABSTRACT

A nasal air filter comprises two hollow nostril adapters, a body, and a filter element. The body is panel shaped to conform to the bottom of the nose. The two hollow nostril adapters for insertion into nostrils at one end and attached side-by-side at the other end to one side of the body via corresponding thru holes on the body. The filter element is secured to the opposite side of the body, creating an open space between the bottom surface of the body and filter element to allow airflow through both nostril adapters and the entire surface area of the filter element. The filter element fitting within the raised edge of the body has a surface area larger than the combined area of the orifices of both nostrils, allowing efficient air filtering and ease of breathing. The device may comprise a nose cover connected around the top edge of the body shaped to conform to the top of the nose.

### FIELD OF INVENTION

The present invention is generally related to air filtering devices for the respiratory health, and more specifically related to nasal air filter devices suitable for use with the human nose.

### BACKGROUND

Humans are often exposed to unhealthy levels of hazardous materials in the air including allergens, pollutants, and dusts. These foreign materials can cause diseases and negative long-term health effect. Thus, there is a strong desire and need to prevent them from being breathed into the lungs or body. Various air filter devices are therefore being used to achieve this goal, including face masks and nasal air filters.

The nose is the primary breathing route. Pollutants and allergens can cause irritation and inflammation in the internal areas of the nose such as the nasal cavity as well as other detrimental effects when breathed into the lungs. Various nose filters have been developed and used to block these foreign materials. There are nasal filters for placement inside the user's nostrils. Such nasal filters may be made entirely of filtering materials or with a supporting mechanism holding the filter element inside the nostrils. There are also nasal masks with a filter element which are secured on the user's nose with a strap. In addition, there are also disk-like filter membranes or pads for covering the nostril orifice with an adhesive. Many of these nasal air filters are designed to be hidden and aesthetically pleasing. Some of the specific examples of current nasal filters or masks are as follows:

U.S. Pat. No. 8,550,079 B2 described a filter layer with an adhesive outer ring for placement onto the nasal orifice.

US20080087286 A1 described a nasal filter with semi-circular ring members for covering the respective nostrils.

U.S. Pat. No. 6,752,149 B2 described a nose mask with a filter member secured on the user's nose with a strap.

U.S. Pat. No. 7,354,467 B2 described a filter assembly with two filtering members for insertion into nostrils.

U.S. Pat. No. 7,748,383 B1 described a nostril plug comprising a self supporting filter material.

However, current nasal filter devices have various shortcomings. These include 1) the small filter area which makes breathing through the filter difficult, 2) direct contact of the filter element with nostril's inner surfaces with potential exposure to nasal secretions which decreases the filtering efficiency, 3) requiring delicate placement deep inside nostrils which can cause discomfort and make it prone to incorrect use, 4) not being convenient and easy to use, especially when frequent use and removal are needed, 5) requiring adhesive or strap to secure the filter device in place, and 6) being of single use and expensive. Thus, there is a strong need for an improved nasal air filter device.

### SUMMARY OF THE INVENTION

Therefore, it is an objective of the present invention to provide a nasal air filter device with a larger filter area for efficient air filtering and ease of breathing.

It is a further objective of the present invention to provide a nasal air filter device with the filter element placed outside of the nostrils and without any contact with skin or nasal inner surface.

It is still a further objective of the present invention to provide a nasal air filter device which can be easily, cleanly, and comfortably placed and removed as frequently as needed.

It is still a further objective of the present invention to provide a nasal air filter device with a replaceable filter element.

Specifically, this nasal air filter device comprises two hollow nostril adapters, a body, and a filter element. The two hollow nostril adapters are adapted for insertion into nostrils at one end and connected side-by-side at the other end to one side of the body via corresponding thru holes on the body. The filter element is secured to the opposite side of the body, but above the bottom surface of the body, thus creating an open space between the bottom surface of the body and filter element to allow airflow through both nostril adapters and the entire surface area of the filter element. The filter element fitting just within the edge of the body has a surface area larger than the combined area of the orifices of both nostrils, thus allowing efficient air filtering and ease of breathing. When nostril adapters are inserted into the nostrils, the body together with the filter element is positioned outside of the nose and in front of the nostril orifices or bottom of the nose. The device may further comprise a nose cover connected around the top edge of the body and shaped to conform to the ridge and ala or top of the nose to enhance the ease of handling and steadiness of the device in use.

Therefore, this nasal air filter device provides a large filter area for efficient air filtering and ease of breathing with the filter element placed outside of the nose. It can be easily, comfortably and cleanly placed and removed as often as needed without a need for an adhesive or strap. It is highly suited for frequent use and removal according to changes in surroundings such as between indoor and outdoor places.

### BRIEF DESCRIPTION OF THE DRAWINGS

FIG. 1 shows the front side view (A) and rear side view (B) of the nasal air filter device.

FIG. 2 shows the components of the nasal air filter device. A, nose cover; B, body with nostril adapters attached; C, filter element support, D, filter element; E, front cover.

FIG. 3 shows the cross-section view of the nasal air filter device.

### DETAILED DESCRIPTION OF THE INVENTION

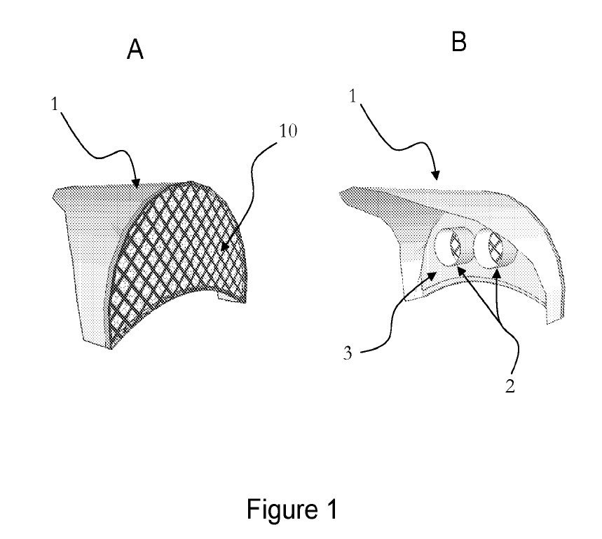

The present nasal air filter device is illustrated in drawings shown in FIGS. 1-3. It comprises three key components: nostril adapters (2), a body (3), and a filter element (9) along with a nose cover (1), filter element support (8), and a front cover (10).

The two nostril adapters (2) are made of a hollow and tubular structure adapted to be inserted into the nostrils at one end and attached at the other end to one side of the body via corresponding thru holes (7) on the body (3). They are suitably sized in diameter to form a firm contact with the nostril walls. They may be shaped like a cylinder, oval or other suitable form to conform to the inner space of the nostrils. They may be attached to the body (3) perpendicularly or at a slight angle to allow easy insertion into nostrils. The firm fitting of the nostril adapters inside the nostrils helps securing the filter device in place.

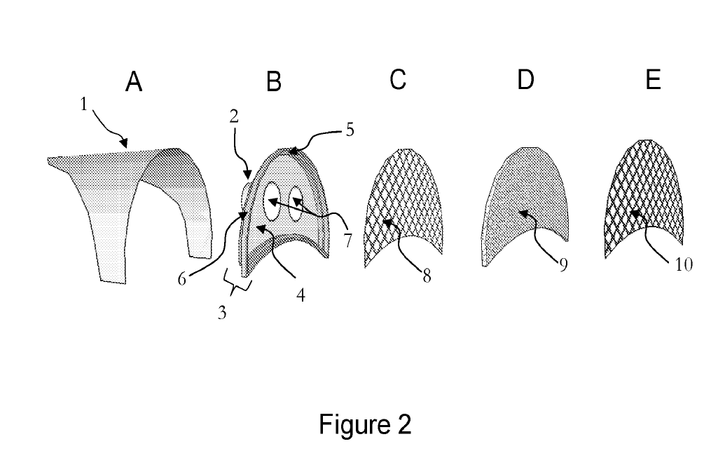

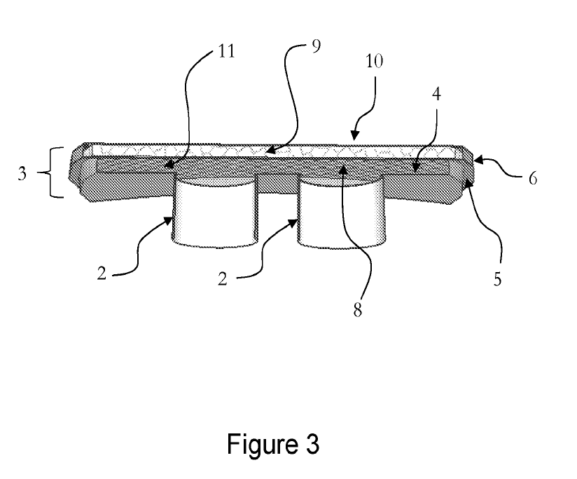

The body (3) is a panel which may be shaped to conform to the bottom of nose which is an area enclosed by the tip, ala, and base of the nose and may have a surface area larger than the bottom of nose (FIGS. 1-3). Its overall shape may be similar to a half circle. It may be flat or slightly curved. The body (3) has two corresponding thru holes (7) to which the two nostril adapters (2) are attached on one side (FIGS. 1-3). On the opposite side, the body has a raised surrounding stepped edge (5 and 6) which supports the placement of the filter element support (8) and filter element (9). The step (5) is raised above the bottom surface (4) of the body (3). Thus, an open space (11) is created between the bottom surface (4) of the body (3) and filter element support (8) (FIGS. 2 and 3), allowing airflow through both nostril adapters (2) and the entire surface area of the filter element (9). The step (5) is raised to a height sufficient to ensure efficient air flow between nostril adapters (2) and the entire surface area of filter element (9). The actual distance in open space between the bottom surface (4) of the body (3) and filter element (9) can range from 0.1 to 15 mm and preferably 0.2 to 7.5 mm.

The filter element (9) is shaped to fit tightly within the edge (6) of the body (3) and secured in place with the front cover (10). The physical size or surface area of the filter element is larger than the combined area of the orifices of both nostrils, thus allowing efficient air filtering and ease of breathing. The filter element (9) is positioned above the bottom surface (4) of the body (3), thus allowing airflow through both nostril adapters (2) and the entire surface area of the filter element (9) via the open space between the bottom surface (4) of the body (3) and filter element support (8). The filter element can be made of any materials suitable for air filtration such as nylon, cellulose, polypropylene, polyester, and sponge. It may possess the electrostatic property and incorporate the activated carbon to enhance the air filtration efficiency. It may further incorporate mechanisms to enhance electrostatic charges such as contact electrification. It can be a thin layer of membrane or a pad made of a single or multiple layers or folds of filter materials. The filter element has a pore size or filter rating sufficient to block allergens and pollutants. It is disposable and easily replaceable. It may be optionally infused with a scent such as mint for a sense of freshness or a medicinal substance.

The front cover (10) is placed in front of the filter element and serves to secure the filter element in place. Both filter element support (8) and front cover (10) are shaped to match the filter element (9) and body (3) (FIG. 2). They can be screens made of suitably spaced thin grids to minimize any hindrance to airflow. The grids may be made with any suitable patterns and styles. The front cover (10) may be secured to the body (3) over the filter element (9) using any suitable locking mechanisms such as a snap lid. It can be easily placed on and removed to allow easy change of the filter element (9). It may be made with a style like the flat over-edge cup lid. The front cover (10) may be replaced with suitable alternative mechanisms for securing the filter element in place such as an overhang extended from the edge of the body (3). The front cover (10) may also help ensuring a proper seal around the edge of the filter element (9) so that air can only flow through the filter element (9).

The nose cover (1) is connected to the top edge of the body (3) and shaped to conform to the ridge and ala or top of the nose (FIG. 1-2). The nose cover (1) is positioned on the top of nose when nostril adapters (2) are inserted into nostrils. It may be made with a flexible and transparent material. It may also incorporate a metal nose band to allow a firmer placement to the top of nose. It increases the ease of handling and the steadiness of the device in use, and also enhances its appearance. In addition, the filter element (9) and body (3) may be extended over a part or entire area of nose cover (1) to further increase filter areas and efficiency.

The body (3), nostril adapters (2), and nose cover (1) may be made with any materials suitable for contact with human skin. They may include hard, semi-rigid, soft and/or elastic materials such as ceramics, polyethylene, polypropylene, polystyrene, rubber, and synthetic polymers. The materials can be transparent, translucent or opaque with a color added. With the filter element removed, the device is suitable for being cleaned with clothes and/or by rinsing with water.

Different variations of the present nasal air filter device may be made based on the principle of this device. It may be made in different sizes and shapes for adults and children. Separate nostril adapters (2) may be made, which have a larger inner diameter and suitable for being placed over the existing ones on the device to increase the overall size or outer diameters of the nostril adapters (2) for tighter or better fit into the nostrils of an individual. Alternatively, the nostril adapters (2) may be attached to the body as a screw with corresponding threads made at end of the nostril adapters (2) and in the thru hole (7) on the body. Thus, different sizes or shapes of the nostril adapters (2) may be made with the same screw end, allowing easy exchange of nostril adapters (2) to obtain a better fit for an individual. The filter element support (8) may be made as a part of the body and secured in place without the need for a stepped edge for support. The filter element support (8), filter element (9), and front cover (10) may be pre-assembled as one replaceable unit for attachment to the body. A slot sliding mechanism may also be introduced on the body (3) to allow lateral movement of the nostril adapters (2) so that the distance between the two nostril adapters can be adjusted to better conform to the nostrils of a user. The whole device with exclusion of filter element and front cover may be made as one piece by 3D printing or other manufacturing processes. It may also be custom-made for a user according to the user's nose measurements such as the diameter of nostrils and the distance between the two nostrils. The device can be provided together with a storage box so that it may be stored cleanly in the box when not in use.

Thus, it is understood that all matters described herein and shown in the accompanying drawings serve to illustrate the principle of the present nasal air filter device without limiting its scope.

1. A nasal air filter device comprising two hollow nostril adapters, a body, and a filter element, wherein
a. said body is a panel;
b. said two hollow nostril adapters are adapted for insertion into nostrils at one end and attached side-by-side at the other end to one side of said body via corresponding thru holes on said body;
c. said filter element is secured to the opposite side of said body, wherein said filter element is positioned above the bottom surface of said body, thereby creating an open space between said filter element and the bottom surface of said body and allowing air flow though said two hollow nostril adapters and the entire surface areas of said filter element.

2. The nasal air filter device of claim 1, wherein said body is shaped to conform to the bottom of nose.

3. The nasal air filter device of claim 1, wherein said body is positioned in front of the bottom of the nose when said two hollow nostril adapters are inserted into nostrils.

4. The nasal air filter device of claim 1, wherein said filter element is enclosed within the edge of said body.

5. The nasal air filter device of claim 1, wherein said filter element has a surface area larger than the combined area of the orifices of both nostrils.

6. The nasal air filter device of claim 1, wherein the distance in open space between said filter element and the bottom surface of said body is 0.1-15 mm and preferably 0.2-7.5 mm.

7. The nasal air filter device of claim 1 further comprises a nose cover attached around the top edge of the said body and shaped to conform to the top of the nose.

8. The nasal air filter device of claim 1, wherein said filter element is replaceable.
